(19) United States
(12) Patent Application Publication
(10) Pub. No.: US 2010/0059165 A1
(43) Pub. Date: Mar. 11, 2010

(54) METHOD OF MANUFACTURING MULTILAYER CERAMIC SUBSTRATE HAVING CAVITY

(75) Inventors: Ho Sung CHOO, Seoul (KR); Jong Myeon Lee, Gwacheon (KR); Yong Seok Choi, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/550,907

(22) Filed: Aug. 31, 2009

(30) Foreign Application Priority Data
Sep. 5, 2008 (KR) 10-2008-0087825

(51) Int. Cl. B32B 37/14

(52) U.S. Cl. 156/89.11

(57) ABSTRACT

A method of manufacturing a multilayer ceramic substrate having a cavity includes preparing a first ceramic laminate having an opening for forming a cavity, and a second ceramic laminate which is to be provided on a bottom surface of the first ceramic laminate, forming a polymer layer in a region corresponding at least to the opening, on a top surface of the second ceramic laminate, forming a desired multilayer ceramic laminate by laminating the first and second ceramic laminates such that the polymer layer of the second ceramic laminate is placed under the opening, laminating first and second constraining layers on a top surface and a bottom surface of the multilayer ceramic laminate, respectively, and sintering the multilayer ceramic laminate including the laminated first and second constraining layers. Accordingly, the strength of a low temperature co-fired ceramic (LTCC) substrate having a cavity is enhanced, and an effective area for mounting built-in devices can be increased.

### CROSS-REFERENCE TO RELATED APPLICATIONS

This application claims the priority of Korean Patent Application No. 2008-0087825 filed on Sep. 5, 2008 in the Korean Intellectual Property Office, the disclosure of which is incorporated herein by reference.

### BACKGROUND OF THE INVENTION

1. Field of the Invention

The present invention relates to a method of manufacturing a multilayer ceramic substrate having a cavity, and more particularly, to a method of manufacturing a multilayer ceramic substrate having a cavity, which can enhance the strength of a low temperature co-fired ceramic (LTCC) substrate having a cavity, and increase an effective area for mounting built-in devices.

2. Description of the Related Art

With the rapid development of mobile devices, electronic appliances are increasingly required to be smaller and multifunctional. This has increased the demand for smaller, multifunctional electronic components. That is, the rapid advancement towards highly integrated modules has led to a sharp increase in the number of electronic components included in a single small module, thus increasing the density of the electronic components within a unit volume. To meet such increasing demand, low temperature co-fired ceramic (LTCC) substrates, developed to have an interposer function and to include built-in passive devices, are required to allow devices such as high-capacity decaps to be additionally mounted therein, hitherto impossible in the related art.

However, in the event of using existing metal patterns, there is a limit in mounting high-capacity decaps or magnetic bodies in LTCC substrates due to the limitations of LTCC materials. An alternative thereto may include bonding different materials, or forming a cavity and mounting an existing passive device within the cavity. The bonding method ensures a simple process but has limitations, in that it is difficult to develop proper materials, thus it would take a considerable amount of time to use the method practically.

In contrast, while the method of mounting a passive device in a cavity requires a relatively complicated process, it also allows for the use of existing materials, thus being utilized in various applications. That is, the method of mounting a passive device inside a cavity allows for the installation of built-in components by use of a cavity formed in a substrate, and can achieve miniaturization by mounting a base-up chip in a cavity even if both welding and the base up chip are used for mounting.

However, if a substrate having a cavity is manufactured by using a general ceramic-substrate manufacturing method, structural defects occur due to the concentration of stress, caused by sintering shrinkage, in the corner or the edge of the bottom of a cavity. Thus, a cavity without defects needs to be achieved for the installation of a passive device in a cavity.

FIG. 1 is a cross-sectional view showing a related art green multilayer ceramic substrate having a cavity before sintering.

As shown in FIG. 1, ceramic green sheets are manufactured, and printed circuit patterns are formed on the ceramic green sheets. Thereafter, the ceramic green sheets including the printed circuit patterns are subjected to hot pressing involving repeated heating and pressing actions, thereby manufacturing upper and lower laminates 12 and 10. Various electronic components are mounted on the surface of the lower laminate 10.

Thereafter, printed circuit patterns are formed on ceramic green sheets. A through hole is formed in the ceramic green sheets by using puncher processing or laser processing as occasion demands. Next, the ceramic green sheets having the through hole are subjected to hot pressing involving repeated heating and pressing actions, thereby manufacturing a cavity wall laminate 11.

By laminating and pressing those ceramic laminates 10, 11 and 12 manufactured as above, a cavity 14 is formed from the through hole in the cavity wall laminate 11. A constraining layer 15 is bonded with one surface of the lower laminate 10 of a ceramic laminate 13, and another constraining layer 16 is also bonded with one surface of the upper laminate 12 of the ceramic laminate 13.

However, in constrained sintering based on the bonding of the constraining layers 15 and 16, the constraining power of the constraining layers 15 and 16 is not fully applied to the bottom of the cavity 14, unlike to the region outside the cavity 14, that is, the upper and lower laminates 12 and 10. This results in different shrinkage rates in the circumferential direction between the bottom of the cavity 14 and the upper and lower laminates 12 and 10, thereby forming defects, such as cracks or voids, at the bottom of the cavity 14.

FIG. 2 is a cross-sectional view showing defects formed at the bottom of a cavity after the process of sintering the ceramic laminate depicted in FIG. 1. As shown in FIG. 2, in constrained sintering using constraining layers, cracks 22 are formed at the corners of a cavity 21, that is, at the boundary of the bottom of the cavity 21 in a sintered ceramic laminate 20, due to the different shrinkage rates in the circumferential direction between the region outside the cavity 21 and the bottom of the cavity 21.

### SUMMARY OF THE INVENTION

An aspect of the present invention provides a method of manufacturing a multilayer ceramic substrate having a cavity, which can suppress defect formation in a cavity, which is caused by sintering shrinkage occurring in constrained sintering.

According to an aspect of the present invention, there is provided a method of manufacturing a multilayer ceramic substrate having a cavity, including: preparing a first ceramic laminate having an opening for forming a cavity, and a second ceramic laminate which is to be provided on a bottom surface of the first ceramic laminate; forming a polymer layer in a region corresponding at least to the opening, on a top surface of the second ceramic laminate; forming a desired multilayer ceramic laminate by laminating the first and second ceramic laminates such that the polymer layer of the second ceramic laminate is placed under the opening; laminating first and second constraining layers on a top surface and a bottom surface of the multilayer ceramic laminate, respectively; and sintering the multilayer ceramic laminate including the laminated first and second constraining layers.

The method may further include removing a sintered material of the sintered first and second constraining layers. The method may further include forming an additional polymer layer in a region corresponding to the opening, on a bottom surface of the first constraining layer, before the laminating of the first and second constraining layers, wherein the additional polymer layer covers a top portion of the opening Also, the method may further include disposing an electronic chip inside the cavity.

At least one of the polymer layer and the additional polymer layer may be formed of a thermoplastic resin, and may be the same as a thermoplastic resin included in the first and second ceramic laminates.

The polymer layer and the additional polymer layer may have areas greater than a formation area of the opening. At least one of the polymer layer and the additional polymer layer may be formed by screen printing or stencil printing.

According to another aspect of the present invention, there is provided a method of manufacturing a multilayer ceramic substrate having a cavity, including: preparing a first ceramic laminate having an opening for forming a cavity, and second and third ceramic laminates which are to be provided on a top surface and a bottom surface of the first ceramic laminate, respectively; forming a first polymer layer in a region corresponding at least to the opening, on a top surface of the second ceramic laminate, and forming a second polymer layer in a region corresponding at least to the opening, on a bottom surface of the third ceramic laminate; laminating the second ceramic laminate such that the first polymer layer is placed under the opening; forming a desired multilayer ceramic laminate by laminating the third ceramic laminate such that the second polymer layer is placed on the opening; bonding a first constraining layer on one surface of the second ceramic laminate and bonding a second constraining layer on one surface of the third ceramic laminate; and sintering the multilayer ceramic laminate including the first and second constraining layers.

The method may further include disposing an electronic chip inside the cavity before the forming of the desired multilayer ceramic laminate. The method may further include removing a sintered material of the sintered first and second constraining layers.

At least one of the first and second polymer layers may be formed of a thermoplastic resin, and may be the same as a thermoplastic resin included in the first to third ceramic laminates.

The first and second polymer layers may have areas greater than a formation area of the opening. At least one of the first and second polymer layers may be formed by screen printing or stencil printing.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view showing a green multilayer ceramic substrate having a cavity before sintering;

FIG. 2 is a cross-sectional view showing a defect formed at the bottom of a cavity after the sintering of a ceramic laminate depicted in FIG. 1;

FIGS. 3A through 3E are cross-sectional views for explaining the process of manufacturing a multilayer ceramic substrate having a cavity, according to an exemplary embodiment of the present invention;

FIG. 4 is a cross-sectional view of a multilayer ceramic substrate after the constrained sintering of a multilayer ceramic laminate depicted in FIG. 3;

FIG. 5 is a cross-sectional view showing a multilayer ceramic laminate before sintering in the process of manufacturing a multilayer ceramic substrate having a cavity, according to another exemplary embodiment of the present invention;

FIG. 6 is a cross-sectional view showing a multilayer ceramic substrate after the constrained sintering of the multilayer ceramic laminate depicted in FIG. 5; and

FIG. 7A is a photographic image showing the cross-section of an actual cavity formed by a general method of manufacturing a multilayer ceramic substrate, using constrained sintering; and

FIG. 7B is a photographic image showing the cross-section of an actual cavity formed by a method of manufacturing a multilayer ceramic substrate having a cavity according to the present invention, using constrained sintering.

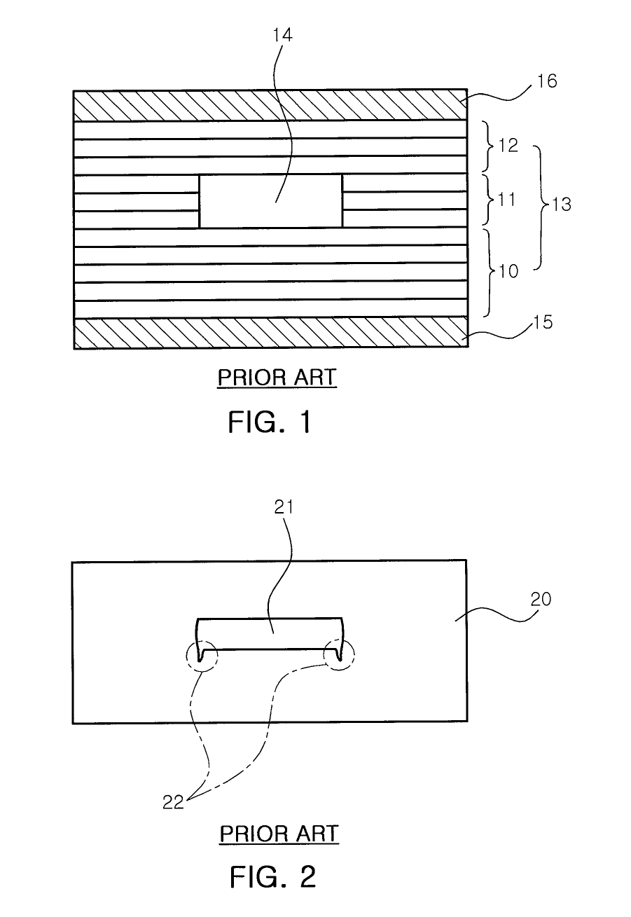

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity.

According to an exemplary embodiment of the present invention, a method of manufacturing a multilayer ceramic substrate having a cavity includes: preparing a first ceramic laminate having an opening for forming a cavity, and second and third ceramic laminates which are to be provided on a top surface and a bottom surface of the first ceramic laminate, respectively; forming a first polymer layer in a region corresponding at least to the opening, on a top surface of the second ceramic laminate, and forming a second polymer layer in a region corresponding at least to the opening, on a bottom surface of the third ceramic laminate; laminating the second ceramic laminate such that the first polymer layer is placed under the opening; forming a desired multilayer ceramic laminate by laminating the third ceramic laminate such that the second polymer layer is placed on the opening; bonding a first constraining layer on one surface of the second ceramic laminate and bonding a second constraining layer on one surface of the third ceramic laminate; and sintering the multilayer ceramic laminate including the first and second constraining layers.

The method of manufacturing a multilayer ceramic substrate having a cavity further includes disposing an electronic chip inside the cavity before the forming of the desired multilayer ceramic laminate. The method further includes removing a sintered material of the sintered first and second constraining layers.

At least one of the first and second polymer layers may be formed of a thermoplastic resin, and may be the same as a thermoplastic resin included in the first to third ceramic laminates. The first and second polymer layers may have areas greater than a formation area of the opening. At least one of the first and second polymer layers may be formed by screen printing or stencil printing.

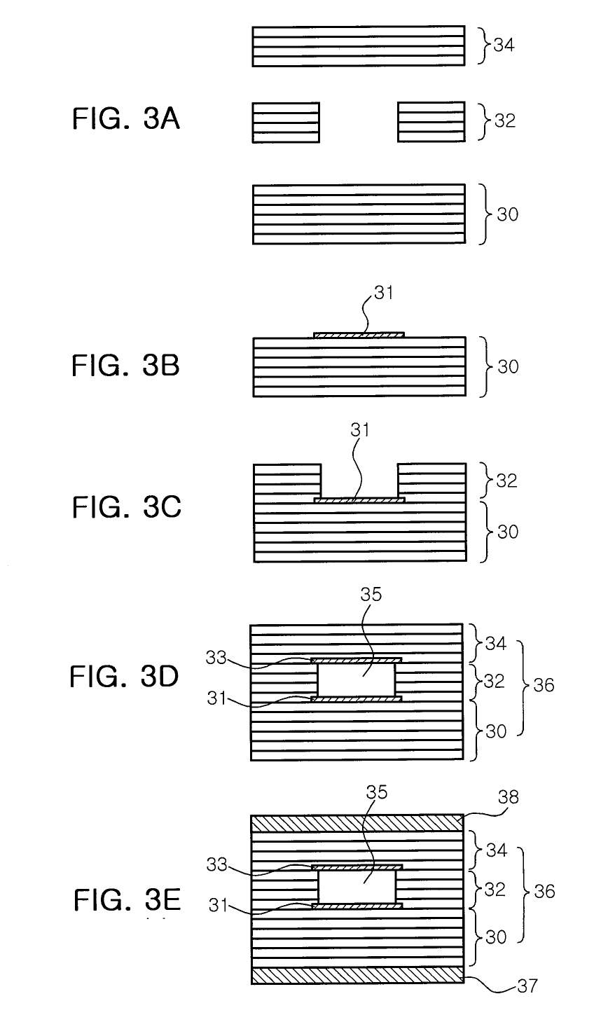

FIGS. 3A through 3E are cross-sectional views for explaining a process of manufacturing a multilayer ceramic substrate having a cavity, according to an exemplary embodiment of the present invention.

In a method of manufacturing a multilayer ceramic substrate having a cavity by using constrained sintering according to the present invention, as shown in FIG. 3A, a plurality of ceramic green sheets are laminated by hot pressing, thereby manufacturing a first ceramic laminate 32 having an opening, and second and third ceramic laminates 30 and 34 disposed on the bottom and the top of the first ceramic laminate 32, respectively.

To manufacture each of the ceramic laminates 30, 32 and 34, glass-ceramic powder is mixed with an organic additive such as a composite solvent, a dispersant, a binder, or a plasticizer, thereby producing a uniform slurry. Subsequently, filtering, defoaming and agitation processes are performed, and ceramic green sheets are manufactured by tape casting. The glass-ceramic powder may be dispersed by adding a predetermined amount of dispersants to the glass-ceramic powder. The binder may utilize an acrylic-based resin, and the composite solvent may utilize toluene and ethanol.

In detail, the produced slurry is subjected to the filtering process to filter out material powder lumps, foreign bodies, and undissolved organic materials. Thereafter, the defoaming and agitation processes are performed to properly control the viscosity of the slurry and remove fine bubbles created during the mixing process, thereby producing a uniform slurry. The slurry prepared in the above manner is manufactured as ceramic green sheets of a desired thickness by use of tape caster equipment. To ensure sheet uniformity in tape casting, the amount of slurry discharged from a blade portion needs to be controlled such that it becomes constant, and the formation of a dried layer on the surface of the slurry needs to be prevented. The general equipment being used to manufacture LTCC sheets may be a comablade type and a doctor blade type, allowing for the molding of a tape having a thickness ranging from a few micrometers to hundreds of micrometers.

The manufactured ceramic green sheets are cut into a predetermined size, and desired printed circuit patterns are formed on the cut ceramic green sheets. Thereafter, the ceramic green sheets with the printed circuit patterns are laminated and pressed, thereby manufacturing the first to third ceramic laminates 30, 32 and 34. The first ceramic laminate 32 may be manufactured by forming an opening in ceramic green sheets using puncher processing or laser processing, and laminating and pressing these ceramic sheets.

Thereafter, as shown in FIG. 3B, a first polymer layer 31 is formed on the second ceramic laminate 30. The first polymer layer 31 is formed corresponding to the inside of the sidewall of the opening in the first ceramic laminate 32, which is to be laminated thereon, and extends into the portion of the interface between the second ceramic laminate 30 and the first ceramic laminate 32. That is, the first polymer layer 31 has a greater area than the formation area of the opening.

The first polymer layer 31 serves to suppress defect formation at a cavity, caused by shrinkage stress applied to the interface between the second ceramic laminate 30 and the first ceramic laminate 32 in subsequent constrained sintering. The first polymer layer 31 utilizes the same thermoplastic resin as the binder used to manufacture the ceramic green sheets, in due consideration of its adhesiveness with the ceramic green sheet and bake-out. As for the thermoplastic resin, an acrylic-based resin or the like may be used.

Thereafter, as shown in FIG. 3C, the second ceramic laminate 30 is laminated to the bottom of the first ceramic laminate 32 including the opening such that the first polymer layer 31 is placed under the opening. The second ceramic laminate 30 is laminated on the bottom of the first ceramic laminate 32 such that the first polymer layer 31 is exposed across the entire circumference of the sidewall of the opening.

As the first ceramic laminate 32 is laminated, a cavity 35 is formed, and an electronic chip (not shown) is mounted inside the cavity 35. An example of the electronic chip mountable inside the cavity 35 may include an integrated chip (IC), a capacitor, an inductor, a resistor, a multilayer ceramic capacitor (MLCC), or a magnetic body. In particular, the mounting of the capacitor and the IC may contribute to increasing an effective area, reducing costs and enhancing performance.

Thereafter, as shown in FIG. 3D, a second polymer layer 33 is formed on the third ceramic laminate 34. Subsequently, the third ceramic laminate 34 is laminated and pressed onto the top of the first ceramic laminate 32. The second polymer layer 33 has a greater area than the boundary of the cavity 35. That is, the formed second polymer layer 33 has a greater area than the formation area of the opening. The second polymer layer 33 is the same as the first polymer layer, and a detailed description thereof will be omitted.

Thereafter, as shown in FIG. 3E, constraining layers 38 and 37 are bonded with the top and bottom of a multilayer ceramic laminate 36 formed in the above manner, respectively. The constraining layers 38 and 37 do not sinter at the sintering temperature of the ceramic laminate 36, thus serving as a shrinkage suppressing layer.

In the process of sintering the multilayer ceramic laminate 36 with which the constraining layers 38 and 37 are bonded, the materials of the first and second polymer layers 31 and 33 are gasified at an initial sintering temperature. This leaves voids at the locations where the first and second polymer layers 31 and 33 are laminated, and the materials of the ceramic laminate 36 flow to the corner of the cavity 35, filling the voids. As a result, the formation of defects such as cracks or voids may be prevented from occurring at the corner of the cavity in constrained sintering. The sintered materials of the sintered constraining layers 38 and 37 are removed.

The first and second polymers 31 and 33 serve to remove the defect of the cavity, which may be created at an early stage of sintering. That is, the first and second polymers 31 and 33 are present at an early stage of sintering but do not remain in a final sintered body, thus they do not involve structural deformation other than the removal of the cavity defect. A polymer usable for the first and second polymer layers 31 and 33 may be a thermoplastic resin. Here, any thermoplastic resin may be used, provided it has a higher bake-out temperature than the polymer of the binder used in manufacturing ceramic green sheets.

Also, any currently available printing method may be used to form the first and second polymer layers 31 and 33, and may include, for example, screen printing or stencil printing. The first and second polymer layers 31 and 33 are placed under and on the opening, respectively, and need to have greater areas than the boundary of the sidewall of the cavity 35. That is, the first and second polymer layers 31 and 33 are formed to have greater areas than the formation area of the opening. However, the excessively large areas of the first and second polymer layers 31 and 33 may cause delamination between the first ceramic laminate 32, and the second or third ceramic laminate 30 and 34. Thus, the first and second polymer layers 31 and 33 are required to have proper areas. To this end, the area of each of the first and second polymer layers 31 and 33 may be greater than the boundary of the sidewall of the cavity 35, that is, the formation area of the opening, by about 50 μm to 1 mm.

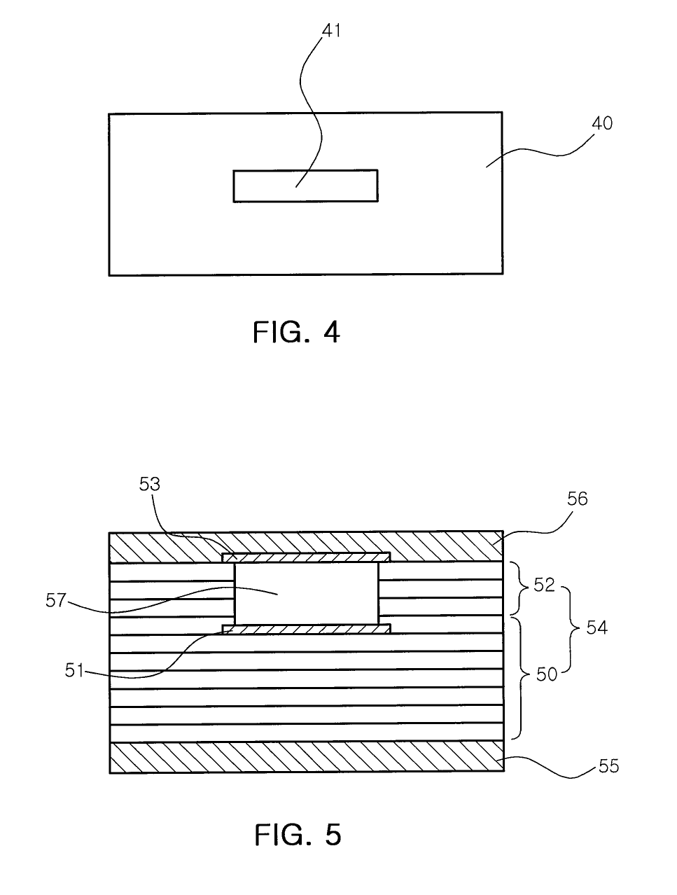

FIG. 4 is a cross-sectional view showing a multilayer ceramic substrate after the constrained sintering of the multilayer ceramic laminate depicted in FIG. 3E. As shown in FIG. 4, in constrained sintering using constraining layers, defect formation does not occur at the corner of a cavity 41 because of the use of the first and second polymer layers.

A method of manufacturing a multilayer ceramic substrate having a cavity, includes: preparing a first ceramic laminate having an opening for forming a cavity, and a second ceramic laminate which is to be provided on a bottom surface of the first ceramic laminate; forming a polymer layer in a region corresponding at least to the opening, on a top surface of the second ceramic laminate; forming a desired multilayer ceramic laminate by laminating the first and second ceramic laminates such that the polymer layer of the second ceramic laminate is placed under the opening; laminating first and second constraining layers on a top surface and a bottom surface of the multilayer ceramic laminate, respectively; and sintering the multilayer ceramic laminate including the laminated first and second constraining layers.

The method of manufacturing a multilayer ceramic substrate having a cavity further includes removing a sintered material of the sintered first and second constraining layers. Also, the method further includes forming an additional polymer layer in a region corresponding to the opening, on a bottom surface of the first constraining layer, before the laminating of the first and second constraining layers, wherein the additional polymer layer covers a top portion of the opening. Also, the method further includes disposing an electronic chip inside the cavity.

At least one of the polymer layer and the additional polymer layer may be formed of a thermoplastic resin, and may be the same as a thermoplastic resin included in the first and second ceramic laminates. The polymer layer and the additional polymer layer may have areas greater than a formation area of the opening. At least one of the polymer layer and the additional polymer layer may be formed by screen printing or stencil printing.

FIG. 5 is a cross-sectional view showing a ceramic laminate including ceramic green sheets laminated to manufacture a multilayer ceramic substrate having a cavity, according to another exemplary embodiment of the present invention.

As shown in FIG. 5, a plurality of ceramic green sheets are laminated and pressed, thereby manufacturing a first ceramic laminate 52 including an opening for forming a cavity, and a second ceramic laminate 50 which is to be disposed under the first ceramic laminate 52.

A polymer layer 51 is formed on the second ceramic laminate 50, and the first ceramic laminate 52 is laminated thereon and pressed. Constraining layers 56 and 55 are bonded with the top and bottom of a resultant multilayer ceramic laminate 54 formed in the above manner, respectively.

An additional polymer layer 53 may be formed on the first ceramic laminate 52. The additional polymer layer 53 may be formed on the first ceramic laminate 52 by forming the additional polymer layer 53 in a region corresponding to the opening on the constraining layer 56, and then bonding the constraining layer 56 with the top of the first ceramic laminate 52. The polymer layer 51 and the additional polymer layer 53 are the same as the first and second polymer layers 31 and 33 described with respect to FIG. 3, and a detailed description thereof will be omitted.

During constrained sintering using these bonded constraining layers 55 and 56 of the multilayer ceramic laminate 54 formed as described above, the laminated polymer layer 51 and the additional polymer layer 53 are gasified at an initial sintering temperature. Then, materials constituting the multilayer ceramic laminate 54 flow, filling a void created by the gasification, thereby suppressing defect formation such as cracks and voids at the corners of a cavity. Here, the defect formation is caused because of the different shrinkage rates in the circumferential direction between the first ceramic laminate 52 and the second ceramic laminate forming the cavity 57.

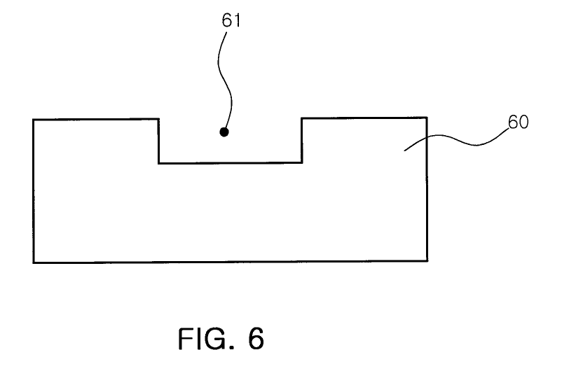

FIG. 6 is a cross-sectional view showing a multilayer ceramic substrate after the constrained sintering of the multilayer ceramic laminate depicted in FIG. 5. As shown in FIG. 6, during constrained sintering using the constraining layers, defects are not formed at the corner, that is, the boundary of the bottom of the cavity 61, by use of the polymer layer and the additional polymer layer.

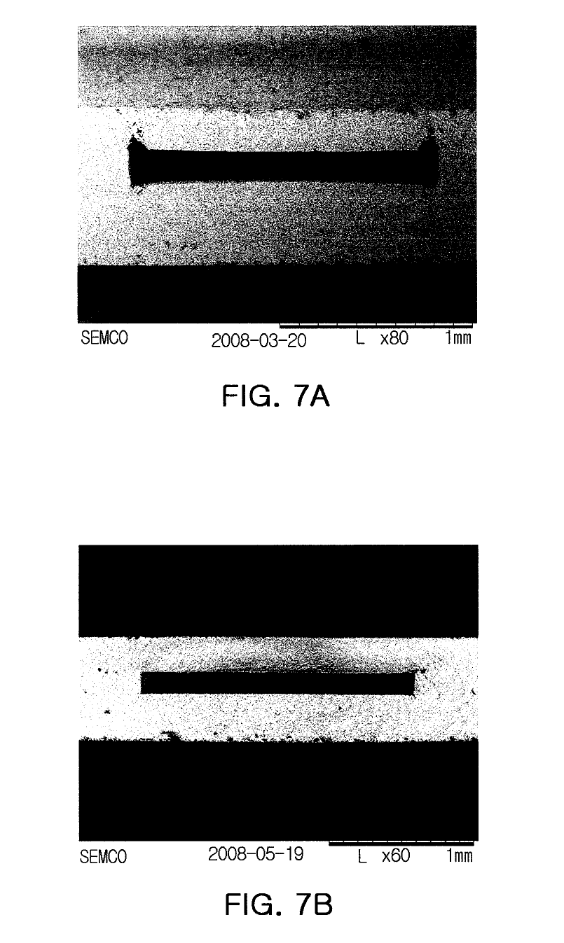

FIG. 7A is a photographic image showing the cross-section of an actual cavity formed by a general method of manufacturing a multilayer ceramic substrate, using constrained sintering. FIG. 7B is a photographic image showing the cross-section of an actual cavity formed by a method of manufacturing a multilayer ceramic substrate having a cavity according to the present invention, using constrained sintering.

Referring to FIG. 7A, it can be seen that the actual cavity formed by the general method of manufacturing a multilayer ceramic substrate has vertical cracks at its corners.

Referring to FIG. 7B, it can be seen in comparison to FIG. 7A that defect formation is suppressed in the actual cavity formed by the method of manufacturing a multilayer ceramic substrate having a cavity according to the present invention.

As set forth above, according to exemplary embodiments of the invention, cavity defects occurring in constrained sintering are suppressed, thereby enhancing the strength of an LTCC substrate having the cavity, and increasing an effective area for mounting electronic components.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a multilayer ceramic substrate having a cavity, the method comprising:
preparing a first ceramic laminate having an opening for forming a cavity, and a second ceramic laminate which is to be provided on a bottom surface of the first ceramic laminate;
forming a polymer layer in a region corresponding at least to the opening, on a top surface of the second ceramic laminate;
forming a desired multilayer ceramic laminate by laminating the first and second ceramic laminates such that the polymer layer of the second ceramic laminate is placed under the opening;
laminating first and second constraining layers on a top surface and a bottom surface of the multilayer ceramic laminate, respectively; and
sintering the multilayer ceramic laminate including the laminated first and second constraining layers.

2. The method of claim 1, further comprising, before the laminating of the first and second constraining layers, forming an additional polymer layer in a region corresponding to the opening, on a bottom surface of the first constraining layer, the additional polymer layer covering a top portion of the opening.

3. The method of claim 1, further comprising removing a sintered material of the sintered first and second constraining layers.

4. The method of claim 1, further comprising disposing an electronic chip inside the cavity.

5. The method of claim 2, wherein at least one of the polymer layer and the additional polymer layer is formed of a thermoplastic resin.

6. The method of claim 2, wherein at least one of the polymer layer and the additional polymer layer is the same as a thermoplastic resin included in the first and second ceramic laminates.

7. The method of claim 2, wherein the polymer layer and the additional polymer layer have areas greater than a formation area of the opening.

8. The method of claim 2, wherein at least one of the polymer layer and the additional polymer layer is formed by screen printing or stencil printing.

9. A method of manufacturing a multilayer ceramic substrate having a cavity, the method comprising:
preparing a first ceramic laminate having an opening for forming a cavity, and second and third ceramic laminates which are to be provided on a top surface and a bottom surface of the first ceramic laminate, respectively;
forming a first polymer layer in a region corresponding at least to the opening, on a top surface of the second ceramic laminate, and forming a second polymer layer in a region corresponding at least to the opening, on a bottom surface of the third ceramic laminate;
laminating the second ceramic laminate such that the first polymer layer is placed under the opening;
forming a desired multilayer ceramic laminate by laminating the third ceramic laminate such that the second polymer layer is placed on the opening;
bonding a first constraining layer on one surface of the second ceramic laminate and bonding a second constraining layer on one surface of the third ceramic laminate; and
sintering the multilayer ceramic laminate including the first and second constraining layers.

10. The method of claim 9, further comprising removing a sintered material of the sintered first and second constraining layers.

11. The method of claim 9, further comprising, before the forming of the desired multilayer ceramic laminate, disposing an electronic chip inside the cavity.

12. The method of claim 9, wherein at least one of the first and second polymer layers is formed of a thermoplastic resin.

13. The method of claim 9, wherein at least one of the first and second polymers is the same as a thermoplastic resin included in the first to third ceramic laminates.

14. The method of claim 9, wherein the first and second polymer layers have areas greater than a formation area of the opening.

15. The method of claim 9, wherein at least one of the first and second polymer layers is formed by screen printing or stencil printing.
